(19) United States
(12) Patent Application Publication
(10) Pub. No.: US 2021/0158708 A1
(43) Pub. Date: May 27, 2021

(54) IDENTIFYING POTENTIAL AIRCRAFT FUEL JETTISON SITES

(71) Applicant: Honeywell International Inc., Morris Plains, NJ (US)

(72) Inventors: Kiran Perikala, Hyderabad (IN); Tulasi Mohan Naraharisetty, Hyderabad (IN); Harikrishna Chitneni, Hyderabad (IN); Hari Krishna Jasti, Hyderabad (IN); Mohan Chandrashekarappa, Bangalore (IN)

(21) Appl. No.: 16/694,649

(22) Filed: Nov. 25, 2019

(51) Int. Cl. G08G 5/00; G05D 1/00

(52) U.S. Cl. CPC G08G 5/0056; B64D 37/26; G05D 1/0066; G08G 5/0039

(57) ABSTRACT

An apparatus and method for identifying potential aircraft fuel jettison and/or burn sites is provided.

### BACKGROUND

In emergency situations, aircrafts may require a reduction in aircraft gross weight. That is, an aircraft in distress possessing weight greater than a maximum landing weight should safely reduce its weight prior to touchdown either by holding until sufficient fuel is burned and optionally fuel jettisoning whenever possible.

Damage to the aircraft may occur if the aircraft attempts to land weighing more than the rated maximum landing weight. Overweight landings not only threaten the safety of the aircraft but also impose additional operational expenses to the operator through mandatory structural checks to be performed per regulations before flying the aircraft again.

Reduction in aircraft gross weight may be achieved through fuel jettisoning or burning (e.g., the aircraft holding in order to burn fuel). Current procedure, in cases of an in-flight emergency where fuel needs to be jettisoned, starts with the pilot notifying air traffic control. Air traffic control then identifies a location where the aircraft can jettison fuel or whether the aircraft should merely hold to burn fuel. This process requires numerous communications back-and-forth between the pilot in the aircraft and air traffic control on the ground to identify a fuel jettison site and determine the amount of fuel weight to jettison, or to determine the amount of fuel weight to burn, where to hold for the burning, and for how long. Air traffic control must take into account the level of distress and the variable time required to get rid of excess fuel and also manage communication required with traffic in the vicinity to stay clear from the distressed aircraft. This communication-intensive approach can be distracting to a pilot who is also attending to matters of the in-flight emergency and can waste valuable time and computing resources.

Furthermore, not all aircrafts are capable of fuel jettisoning—in which case, the complete weight reduction procedure is dependent purely on holding until a time at which the excess fuel is consumed by burning the same.

### SUMMARY

Embodiments of the present disclosure are directed to an apparatus for identifying potential aircraft fuel jettison and/or burn sites. In embodiments, an apparatus for generating aircraft emergency solution data structures comprises at least one processor and at least one memory storing instructions that, with the at least one processor, cause the apparatus to identify and facilitate navigation to potential aircraft fuel jettison and/or burn sites.

In embodiments, the apparatus is configured to receive an in-flight emergency notification data structure associated with an aircraft identifier. In embodiments, the aircraft identifier is associated with an aircraft.

In embodiments, the apparatus is further configured to generate an aircraft emergency solution data structure. In embodiments, the aircraft emergency solution data structure is generated based at least in part on the in-flight emergency notification data structure, aircraft location coordinates, and an aircraft attribute data structure. In embodiments, wherein aircraft emergency solution data structure comprises excess fuel solution location coordinates, one or more of a fuel burn instruction or a fuel jettison instruction, and an excess fuel amount.

In embodiments, the apparatus is further configured to navigate the aircraft to a location associated with the excess fuel solution location coordinates.

In embodiments, the apparatus is further configured to, upon detecting that current aircraft location coordinates match excess fuel solution location coordinates, maintain an aircraft position in the current aircraft location coordinates for an excess fuel solution amount of time comprising an amount of time sufficient for an amount of fuel to be burned equivalent to the excess fuel amount or an amount of fuel to be jettisoned equivalent to the excess fuel amount.

Methods and computer program products corresponding to the above-summarized apparatuses are also described and claimed herein.

Additional features and advantages are realized through the techniques of the present disclosure. Other embodiments and aspects of the disclosure are described in detail herein and are considered a part of the claimed disclosure. For a better understanding of the disclosure with advantages and features, refer to the description and to the drawings.

### BRIEF DESCRIPTION OF THE FIGURES

The subject matter which is regarded as the disclosure is particularly pointed out and distinctly claimed in the claims at the conclusion of the specification. The foregoing and other objects, features, and advantages of the disclosure are apparent from the following detailed description taken in conjunction with the accompanying drawings in which:

FIGS. 1A, 1B, and 1C illustrate exemplary systems within which embodiments of the present disclosure may operate;

FIG. 2 illustrates an exemplary apparatus for use with embodiments of the present disclosure;

FIG. 3 illustrates an exemplary list of candidate fuel reduction sites and an interface comprising an exemplary graphical highway-on-the-sky map, according to embodiments of the present disclosure;

FIG. 4 illustrates exemplary operations for generation of an aircraft emergency solution data structure, according to embodiments of the present disclosure;

FIG. 5A illustrates exemplary operations for generating a trained emergency solutions model, according to embodiments of the present disclosure; and

FIG. 5B illustrates exemplary operations for applying a trained emergency solutions model to a real time input vector, according to embodiments of the present disclosure.

The detailed description explains the preferred embodiments of the disclosure, together with advantages and features, by way of example with reference to the drawings.

### DETAILED DESCRIPTION

In cases of in-flight emergency requiring fuel to be jettisoned or burned (i.e., reduced) by an aircraft, conventional approaches are heavily reliant upon air traffic control (ATC) for fuel jettison or burn site identification. In addition, conventional approaches lack technical solutions which allow the pilots in the cockpit to proactively identify a suitable list of candidate fuel jettison or burn sites based on current weather and other conditions.

Another advantage of the present disclosure is the ability to calculate the amount of fuel weight to jettison or burn based on several factors. Such factors include considering the maximum take-off weight of the aircraft, the maximum landing weight of the aircraft, and a fuel burn amount of weight consumed by the aircraft from a take-off airport to the fuel jettison location and then from the fuel jettison location to a landing airport. According to embodiments of the present disclosure, less fuel must be jettisoned or burned, saving time, fuel cost, and potentially avoiding further hazards.

Another advantage of the present disclosure is the ability to determine the altitude in which to jettison fuel based, in part, on weather conditions. Such determination is important so that the fuel jettisoned vaporizes before reaching the ground.

The present system reduces required communications between a distressed aircraft and Air Traffic Control, thereby reducing wasted resources (i.e., communication bandwidth, communication resources), wasted time (i.e., the use of critical emergency solution time for communication instead of action), and potential points of failure (i.e., if an emergency solution is dependent upon ATC communications, if communication lines to ATC are unavailable, severe consequences arise).

As used herein, the terms “data object”, “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices/entities, such as, for example, one or more servers, relays, routers, network access points, base stations, hosts, and/or the like, sometimes referred to herein as a “network.” Similarly, where a computing device is described herein to transmit data to another computing device, it will be appreciated that the data may be sent directly to another computing device or may be sent indirectly via one or more intermediary computing devices/entities, such as, for example, one or more servers, relays, routers, network access points, base stations, hosts, and/or the like.

The terms “dataset” and “data set” refer to a collection of data. A data set can correspond to the contents of a single database table, or a single statistical data matrix, where every column of the table represents a particular variable (e.g., a predictor variable), and each row corresponds to a given member (e.g., a data record) of the data set in question. The data set can be comprised of tuples (e.g., feature vectors). In embodiments, a data set lists values for each of the variables, such as height and weight of an object, for each member (e.g., data record) of the data set. Each value is known as a datum. The data set may comprise data for one or more members, corresponding to the number of rows.

The term “data record” refers to an electronic data value within a data structure. A data record may, in some embodiments, be an aggregate data structure (e.g., a tuple or struct). In embodiments, a data record is a value that contains other values. In embodiments, the elements of a data record are referred to as fields or members. In embodiments, data may come in records of the form: (x, Y)=(x₁, x₂, x₃, . . . , xₖ, Y) where the dependent variable Y is the target variable that the model is attempting to understand/classify, or generalize. The vector x (i.e., feature vector) is composed of the features x₁, x₂, x₃, etc. that are used for the task. The features may be representative of attributes associated with a data record.

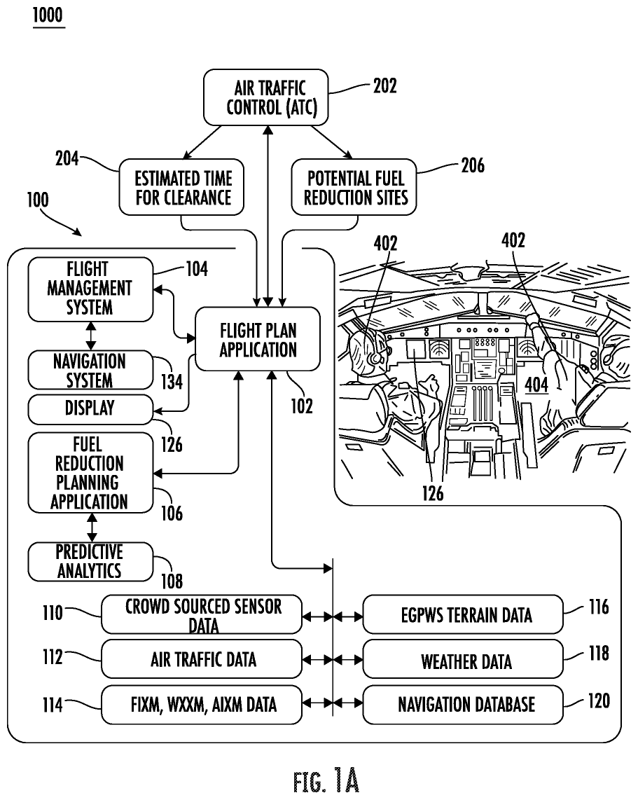

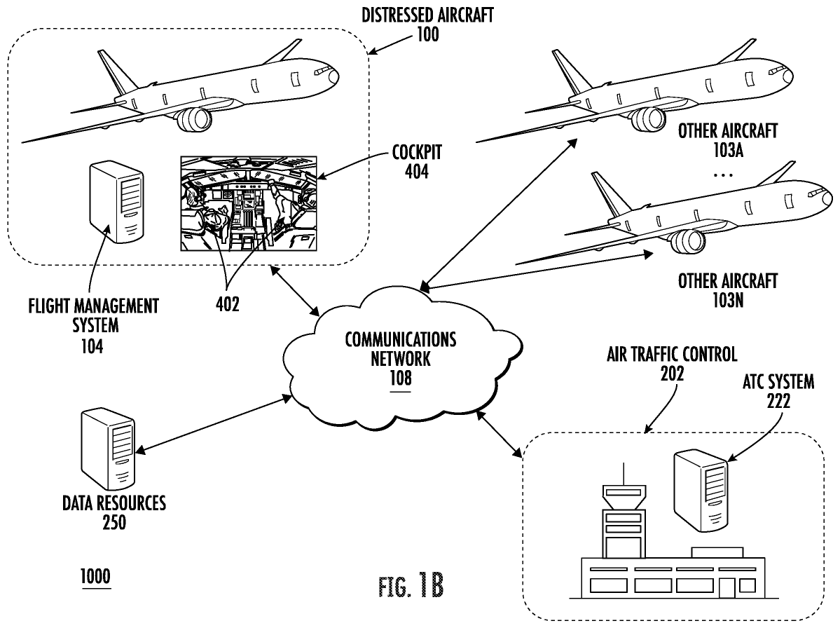

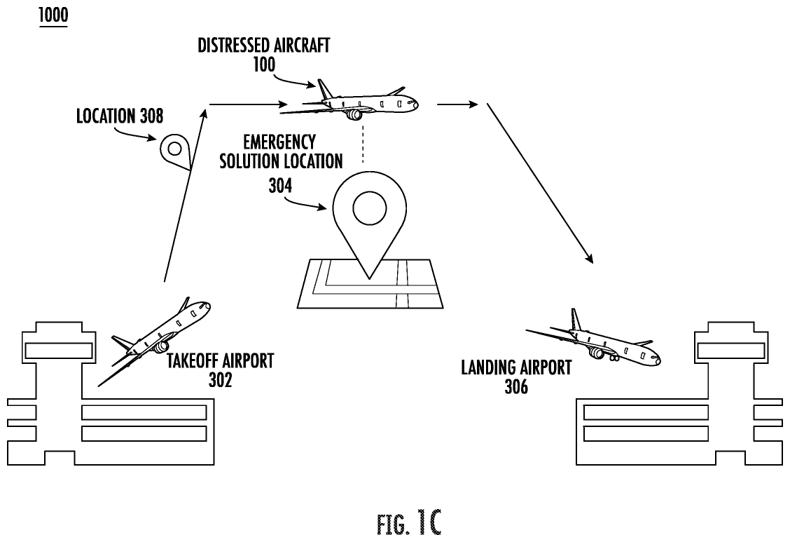

FIGS. 1A, 1B, and 1C illustrate exemplary systems within which embodiments of the present disclosure may operate. In an exemplary embodiment, a system 1000 comprises a flight management apparatus 100 configured for operation in the cockpit 404 of an aircraft (e.g., distressed aircraft 100) and for operation by one or more pilots 402.

A flight plan application 102 can act as a central control point for pilot 402 interactions. In this regard, a flight plan application 102 can initiate the flight plan and engender other systems such as the flight management system 104 and associated aircraft navigation system 134 to execute the flight plan. This includes data communicating with other in-aircraft and out-of-aircraft applications, databases, data processing resources, and other system, as may be required and/or desired in a particular embodiment.

The flight plan application 102 communicates data, voice, and other signals with an air traffic control (ATC) 202 system or device 222. One such communication can include estimated time for clearance 204. In an exemplary embodiment, in the context of an in-flight emergency requiring fuel to be reduced, the estimated time for clearance (ETC) 204 is an estimation of time when the ATC system 222 will be in a position to transmit approval or otherwise authorization of a preferred fuel reduction site identifier for fuel reduction.

Additionally, the flight plan application 102 communicates data, voice, and other signals with the ATC device 222 including receiving potential fuel reduction site identifiers 206. In this regard, the apparatus and methods of the present disclosure can generate a list of candidate fuel reduction site identifiers 310, as well as receive potential fuel reduction site identifiers 206 from the ATC system 222.

In embodiments, the flight plan application 102 communicates data with a fuel reduction planning application 106. In an exemplary embodiment, the fuel reduction planning application 106 comprises a trained emergency solutions model (e.g., see 504) that is configured, upon receiving indication of an in-flight aircraft emergency, to determine a list of candidate fuel reduction site identifiers 310. The list of candidate fuel reduction site identifiers 310 can be ranked based, in part, on total flight distance from the aircraft current location 308 to the candidate fuel reduction site plus flight distance from the candidate fuel reduction site location to a landing airport 306. The list of candidate fuel reduction site identifiers 310 can also be ranked based, in part, on minimizing the amount of fuel weight needed to be reduced (i.e., jettisoned and/or burned) upon reaching the candidate fuel site reduction location coordinates.

In another exemplary embodiment, responsive to receiving a data structure indicating an aircraft in-flight emergency, a preferred fuel reduction site identifier selected from a list of candidate fuel reduction site identifiers 310 can be determined using the trained emergency solutions model 504, as well as other integrated applications and in-aircraft and out-of-aircraft data sources and data processing resources.

Once the preferred fuel reduction site identifier and the list of candidate fuel reduction site identifiers have been determined they can be transmitted to ATC system 222. A navigation system 134 can provide location coordinates associated with the preferred fuel reduction site identifier, such that the navigation system 134 is configured to navigate the aircraft to the location coordinates associated with the preferred fuel reduction site identifier. Such a navigation system 134 can be and/or can be integrated with the flight management system 104.

A fuel weight amount (i.e., excess fuel amount) to reduce from the aircraft can be calculated. Moreover, upon detecting arrival of the aircraft 100 at the location coordinates (e.g., emergency solution location 304) associated with the preferred fuel reduction site identifier, the fuel weight amount can be reduced by way of burn and/or jettisoning from the aircraft 100. The navigation system 134 can then be provided location coordinates associated with a landing airport 306.

In an exemplary embodiment, minimizing the amount of fuel weight for jettison or burn involves calculating a fuel burn weight. The fuel burn weight is based at least in part on the weight of fuel consumed during aircraft 100 flight and is determined by flight distance from the take-off airport 302 to a current position 308 of the aircraft 100 plus flight distance from the current position 308 of the aircraft 100 to the preferred fuel reduction site coordinates (e.g., emergency solution location 304) plus flight distance from the preferred fuel reduction site coordinates (e.g., emergency solution location 304) to the landing airport 306.

In an exemplary embodiment, the amount of fuel weight to reduce or eliminate from the aircraft 100 can be calculated by subtracting from a maximum take-off weight of the aircraft 100, a maximum landing weight of the aircraft 100 and the fuel burn weight of the aircraft 100. As an example, the aircraft 100 maximum take-off weight can be 600,000 pounds and the maximum landing weight of the aircraft 100 can be 524,000 pounds. This would suggest 136,000 pounds of fuels weight would need to be jettisoned and/or burned before landing. However, calculating a fuel burn weight, as an example, 16,000 pounds means that only 120,000 pounds of fuel need to be jettisoned or burned from the aircraft 100. Thus, time savings can be realized as well as a fuel cost savings can be realized by jettisoning or burning less fuel from the aircraft 100 while satisfying the maximum landing weight requirement. Each of the candidate fuel reduction site identifiers 310 can be evaluated in this manner as well as in other manners and ranked in the list of the candidate fuel reduction site identifiers 310.

The flight plan application 102 can data communicate with a plurality of in-aircraft and remote out-of-aircraft data processing resources 250 (i.e., as local repositories or as remote resources from which data is received via a communications network 108). In this regard, such data processing resources 250 can include at least one of enhanced ground proximity warning system (EGPWS) terrain data 116, weather data 118, navigation data 120, crowd-sourced sensor data 110, air traffic data 112, performance data 112, and/or flight information exchange model (FIXM) data, weather information exchange model (WXXM) data, or aeronautical information exchange model (AIXM) data 114 (i.e., FIXM, WXXM, AIXM data 114).

Such data processing resources and data 250 can be used by predictive analytics component 108. The predictive analytics component 108 communicates with the fuel reduction planning application 106. The predictive analytics components 108 data processes FIXM, WXXM, AIXM data 114 and other data to establish relationships between two or more of the data elements.

In an exemplary embodiment, the predictive analytics component 108 can develop the algorithms and statistical models needed to perform specific tasks and build the list of fuel jettison sites without using explicit instructions, relying on patterns and inferences instead. In embodiments, the predictive analytics component 108 is configured to assist the trained emergency solutions model (e.g., see 504) in accomplishing operations described herein.

In an exemplary embodiment, the list of candidate fuel reduction site identifiers 310, the preferred fuel reduction site identifier 304, a graphical highway-on-the-sky map 312, results, data, and other information can be rendered for display to the pilot 402 on a cockpit 404 display 126. Data communication can also be effectuated between the flight plan application 102 and the ATC system 222.

The flight plan application 102 can also access or otherwise data communicate with crowed-sourced sensor data 110. In an exemplary embodiment such crowd-sourced sensor data 110 can be data collected from aircraft 100, as well as other aircraft 103A-103N in the area. Such data is useful in understanding where air turbulence is present, as well as atmospheric conditions, and for forming other data insights, as may be required and/or desired in a particular embodiment. This data can be useful in determining the list of the candidate fuel reduction site identifiers and ultimately selecting the preferred fuel reduction site identifier.

A take-off airport 302 is associated with an origination of aircraft 100 flight. The current location 308 indicates the current position of the aircraft 100 in-flight. Such current position can be the global position system (GPS) location and can include the altitude of the aircraft 100. A fuel reduction site (i.e., emergency solution location) 304 indicates the location where the aircraft 100 can or will jettison and/or hold to burn fuel. A landing airport 306 indicates where the aircraft 100 will land after jettisoning and/or holding to burn fuel.

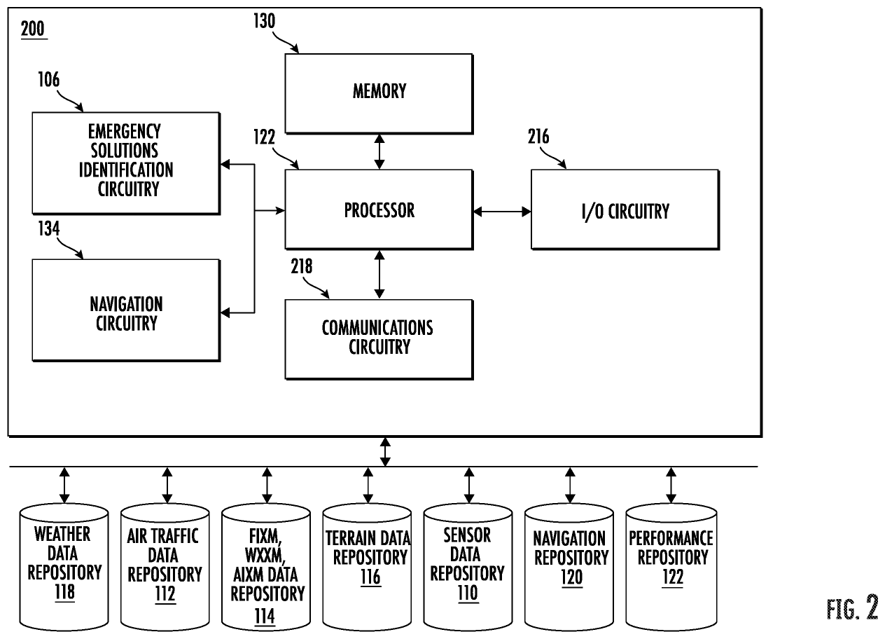

Each flight management system 104 may be embodied by one or more computing systems, such as apparatus 200 shown in FIG. 2. The apparatus 200 may include processor 122, memory 130, input/output circuitry 216, communications circuitry 218, navigation circuitry 134, and emergency solutions identification circuitry 106. The apparatus 200 may be configured to execute the operations described herein. Although these components are described with respect to functional limitations, it should be understood that the particular implementations necessarily include the use of particular hardware. It should also be understood that certain of these components may include similar or common hardware. For example, two sets of circuitries may both leverage use of the same processor, network interface, storage medium, or the like to perform their associated functions, such that duplicate hardware is not required for each set of circuitries.

In some embodiments, the processor 122 (and/or co-processor or any other processing circuitry assisting or otherwise associated with the processor) may be in communication with the memory 130 via a bus for passing information among components of the apparatus. The memory 130 is non-transitory and may include, for example, one or more volatile and/or non-volatile memories. In other words, for example, the memory 204 may be an electronic storage device (e.g., a computer-readable storage medium). The memory 130 may be configured to store information, data, content, applications, instructions, or the like for enabling the apparatus to carry out various functions in accordance with example embodiments of the present invention.

The processor 122 may be embodied in a number of different ways and may, for example, include one or more processing devices configured to perform independently. In some preferred and non-limiting embodiments, the processor 122 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 122 may be configured to execute instructions stored in the memory 130 or otherwise accessible to the processor 122. In some preferred and non-limiting embodiments, the processor 122 may be configured to execute hard-coded functionalities. As such, whether configured by hardware or software methods, or by a combination thereof, the processor 122 may represent an entity (e.g., physically embodied in circuitry) capable of performing operations according to an embodiment of the present invention while configured accordingly. Alternatively, as another example, when the processor 122 is embodied as an executor of software instructions, the instructions may specifically configure the processor 122 to perform the algorithms and/or operations described herein when the instructions are executed.

In some embodiments, the apparatus 200 may include input/output circuitry 216 that may, in turn, be in communication with processor 122 to provide output to the user and, in some embodiments, to receive an indication of a user input. The input/output circuitry 216 may comprise a user interface and may include a display, and may comprise a web user interface, a mobile application, a client device, a kiosk, or the like. In some embodiments, the input/output circuitry 216 may also include a keyboard, a mouse, a joystick, a touch screen, touch areas, soft keys, a microphone, a speaker, or other input/output mechanisms appropriate for use within an aircraft. The processor and/or user interface circuitry comprising the processor may be configured to control one or more functions of one or more user interface elements through computer program instructions (e.g., software and/or firmware) stored on a memory accessible to the processor (e.g., memory 130, and/or the like).

The communications circuitry 218 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 218 may include, for example, a network interface for enabling communications with a wired or wireless communication network. For example, the communications circuitry 218 may include one or more network interface cards, antennae, buses, switches, routers, modems, and supporting hardware and/or software, or any other device suitable for enabling communications via a network. Additionally or alternatively, the communications circuitry 218 may include the circuitry for interacting with the antenna/antennae to cause transmission of signals via the antenna/antennae or to handle receipt of signals received via the antenna/antennae.

Emergency solutions circuitry 106 includes hardware configured to receive and distribute data structures based on real time input vectors and a trained machine learning model. The emergency solutions circuitry 106 may utilize processing circuitry, such as the processor 122, to perform these actions. However, it should also be appreciated that, in some embodiments, the emergency solutions circuitry 106 may include a separate processor, specially configured Field Programmable Gate Array (FPGA), or Application Specific Integrated Circuit (ASIC) for performing the functions described herein. The emergency solutions circuitry 106 may be implemented using hardware components of the apparatus configured by either hardware or software for implementing these planned functions.

Navigation circuitry 134 includes hardware configured to receive and distribute location coordinates and utilize location coordinates for navigation of aircraft 100. The navigation circuitry 134 may utilize processing circuitry, such as the processor 122, to perform these actions. However, it should also be appreciated that, in some embodiments, the navigation circuitry 134 may include a separate processor, specially configured Field Programmable Gate Array (FPGA), or Application Specific Integrated Circuit (ASIC) for performing the functions described herein. The navigation circuitry 134 may be implemented using hardware components of the apparatus configured by either hardware or software for implementing these planned functions.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

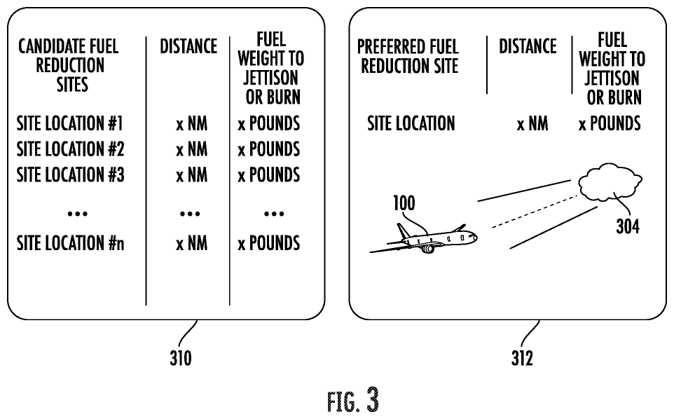

FIG. 3 illustrates an exemplary interface comprising a list of candidate fuel reduction site identifiers 310 and graphical highway-on-the-sky map 312 (i.e., an interface renderable for display, where the interface comprises renderable components representative of a map comprising fuel reduction site information). In an exemplary embodiment, a preferred fuel reduction site identifier and a list of candidate fuel reduction site identifiers 310 can be generated and made accessible to the pilot 402 by way of a cockpit 404 display 126 (i.e., instructions for rendering are provided). The preferred fuel reduction site identifier, list of candidate fuel reduction sites, and other data can be transmitted or otherwise data communicated to an ATC system 222. The preferred fuel reduction site identifier and the list of candidate fuel reduction site identifiers 310 can include for each site the global position system (GPS) location (i.e., latitude and longitude coordinates), present fuel state of the aircraft 100, recommended altitude to reduce fuel so the fuel vaporizes before reaching the ground, the distance to the location in nautical miles (NM) or other convenient measurements such as time, miles, kilometers, or other unit of measure, a calculation as to how many pounds of fuel to jettison and/or burn, and other information, as may be required and/or desired in a particular embodiment.

Once a preferred fuel reduction site identifier 304 has been selected, a graphical highway-on-the-sky map 312 can be displayed to the pilots 402 on a cockpit 404 display 126 to aid navigation. Such a graphical highway-on-the-sky map 312 can include a visual representation of the route, distance, time to the preferred fuel reduction site 304, and other information, as maybe required and/or desired in a particular embodiment. The graphical highway-on-the-sky map 312 can also display other useful information to the pilot 402 such as a calculation of how many pounds of fuel to jettison and/or burn upon reaching the preferred fuel reduction site 304 and other useful information, as may be required and or desired in a particular embodiment.

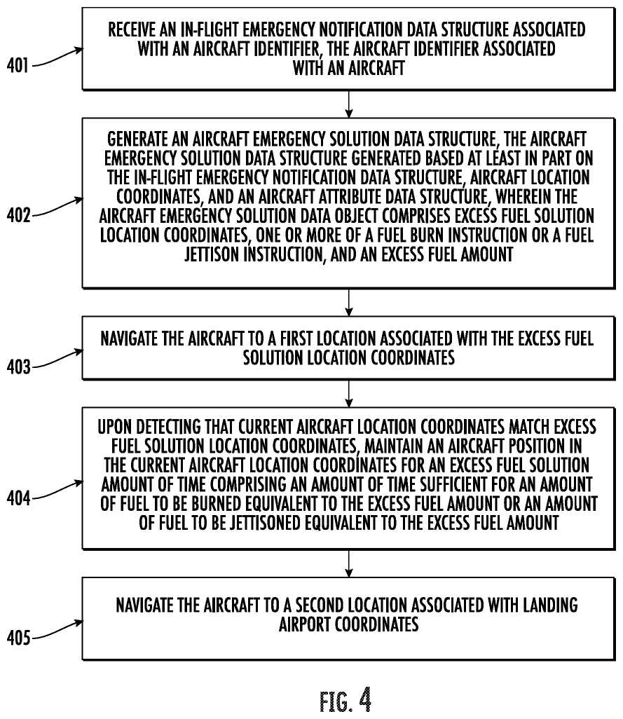

FIG. 4 illustrates exemplary operations for generation of an aircraft emergency solution data structure, according to embodiments of the present disclosure.

In embodiments, an in-flight emergency notification data structure is received 401. In embodiments, the in-flight emergency notification data structure is associated with an aircraft identifier (i.e., an identifier of a distressed aircraft 100). In embodiments, the aircraft identifier may be used to retrieve aircraft attributes used for generating an emergency solution data structure. In embodiments, the in-flight emergency notification data structure can be received by a flight management system 104 embodied by an exemplary apparatus 200.

In embodiments, an aircraft emergency solution data structure is generated 402. In embodiments, the aircraft emergency solution data structure is generated based at least in part on the in-flight emergency notification data structure, aircraft location coordinates, and an aircraft attribute data structure. In embodiments, the aircraft emergency solution data structure comprises excess fuel solution location coordinates, one or more of a fuel burn instruction or a fuel jettison instruction, and an excess fuel amount. In embodiments, an aircraft emergency solution data structure is generated based at least in part on a trained emergency solutions model.

In embodiments, the aircraft is navigated 403 to a first location associated with excess fuel solution location coordinates (e.g., emergency solution location coordinates and/or preferred fuel reduction side coordinates).

In embodiments, upon detecting that current aircraft location coordinate match the excess fuel solution location coordinates, the aircraft position in maintained 404 in the current aircraft location coordinates for an excess fuel solution amount of time. In embodiments, the excess fuel solution amount of time comprises one or more of an amount of time sufficient for an amount of fuel to be burned equivalent to the excess fuel amount, an amount of fuel to be jettisoned equivalent to the excess fuel amount, or an amount of fuel to be burned and jettisoned equivalent to the excess fuel amount.

In embodiments, the aircraft is then navigated 405 to a second location associated with landing airport coordinates.

In embodiments, a preferred fuel reduction site and the list of candidate fuel reduction sites is transmitted to air traffic control (ATC).

In an exemplary embodiment, the system may, selectively, wait for ATC or other approval before navigating to the preferred fuel reduction site 304. In addition, the pilots 402 and/or ATC may execute a checklist to ensure proper procedures are being followed.

In an exemplary embodiment, the checklist includes steps or tasks to perform, requirements, authorizations, and other checklist items that need to occur prior to jettisoning and/or burning fuel from the aircraft 100. Such steps or tasks, requirements, authorizations, and other checklist items can include interactions with air traffic control 202, as required and/or desired in a particular embodiment.

In an exemplary embodiment, ATC transmits an approval message notifying the system that it is approved for navigation to the preferred fuel reduction site and/or navigation to the landing airport. In embodiments, ATC transmits a message to surrounding aircraft in the area notifying them that an aircraft (e.g., aircraft 100) will be jettisoning and/or burning fuel at the preferred fuel reduction site. In embodiments, the system transmits to ATC a confirmation once the excess fuel amount is reduced from the aircraft. In embodiments, ATC transmits a message to surrounding aircraft in the area notifying them that the fuel jettisoning and/or burning is complete. In embodiments, surrounding aircraft are prohibited from entering a radius of 5NM around the preferred fuel reduction site.

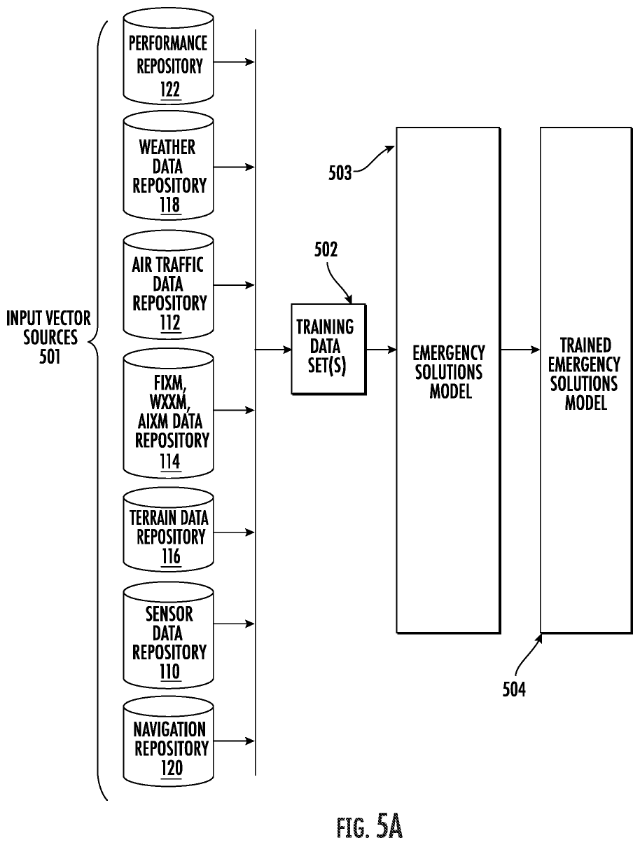

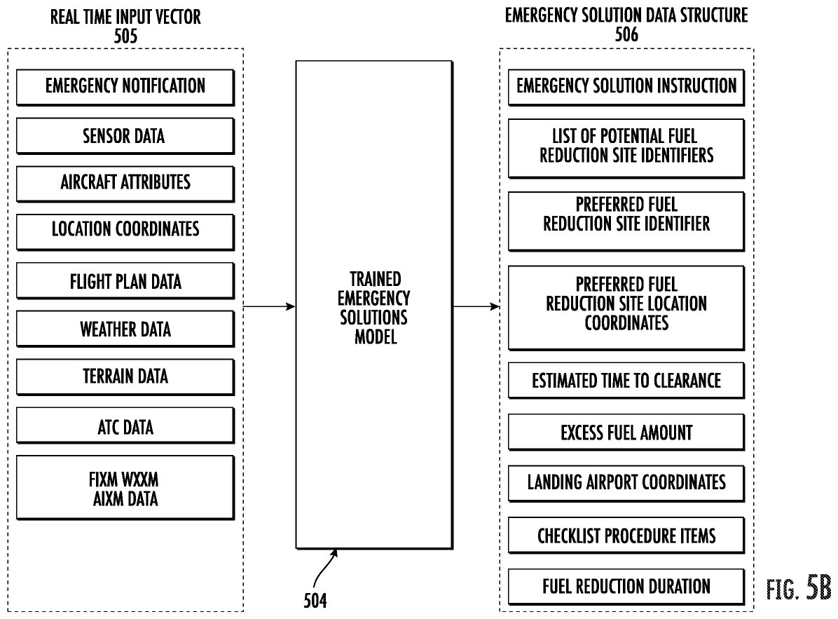

FIG. 5A illustrates exemplary operations for generating a trained emergency solutions model, according to embodiments of the present disclosure. In embodiments, an emergency solutions model 503 is trained using one or more training data sets 502 comprised of input vectors from a plurality of input vector sources 501. In embodiments, exemplary input vector sources include a performance repository 122, a weather data repository 118, an air traffic data repository 112, FIXM/WXXM/AIXM data repository 114, terrain data repository 116, sensor data repository 110, and navigation repository 110. It will be appreciated that additional repositories, local or remote, may comprise data for use in building the one or more training data sets 502 for training the emergency solutions model 503. The input vector sources 501 provide data objects for inclusion in feature vectors, each comprising a plurality of records and each record associated with a data object.

The one or more training data sets 502 are used to train the emergency solutions model 503 to produce a trained emergency solutions model. In embodiments, the emergency solutions model 503 comprises one or more machine learning models.

The term “machine learning model” refers to a machine learning task. Machine learning is a method used to devise complex models and algorithms that lend themselves to prediction. A machine learning model is a computer-implemented algorithm that can learn from data without relying on rules-based programming. These models enable reliable, repeatable decisions and results and uncovering of hidden insights through machine-based learning from historical relationships and trends in the data.

A machine learning model is initially fit or trained on a training dataset (e.g., a set of examples used to fit the parameters of the model). The model can be trained on the training dataset using supervised or unsupervised learning. The model is run with the training dataset and produces a result, which is then compared with a target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). In some embodiments, the machine learning model is a regression model. The term “target variable” refers to a value that a machine learning model is designed to predict. In the present embodiments, historical data is used to train a machine learning model to predict the target variable. Historical observations of the target variable are used for such training.

The term “feature vector” refers to an n-dimensional vector of features that represent an object. N is a number. Many algorithms in machine learning require a numerical representation of objects, and therefore the features of the feature vector may be numerical representations.

In the pattern recognition field, a pattern is defined by the feature xi which represents the pattern and its related value yi. For a classification problem, yi represents a class or more than one class to which the pattern belongs. For a regression problem, yi is a real value. For a classification problem, the task of a classifier is to learn from the given training dataset in which patterns with their classes are provided. The output of the classifier is a model or hypothesis h that provides the relationship between the attributes xi and the class yi. The hypothesis h is used to predict the class of a pattern depending upon the attributes of the pattern. Neural networks, naive Bayes, decision trees, and support vector machines are popular classifiers.

In decision analysis, a decision tree can be used to visually and explicitly represent decisions and decision making. In data mining, a decision tree describes data (but the resulting classification tree is used as an input for decision making).

In embodiments, a decision tree is in the form of a tree structure, where each node is either a leaf node (indicates the prediction of the model), or a split node (specifies some test to be carried out on a single attribute-value), with two branches. A decision tree can be used to make a prediction by starting at the root of the tree and moving through it until a leaf node is reached, which provides the prediction for the example.

In decision tree leaning, the goal is to create a model that predicts the value of a dependent variable based on several independent variables. Each leaf of the decision tree represents a value of the dependent variable given the values of the independent variables, represented by the path from the root to the leaf (passing through split nodes).

In embodiments, the trained emergency solutions model 504 employs a series of decision tree-based predictions in order to predict each record/attribute of an emergency solution data structure.

FIG. 5B illustrates exemplary operations for applying a trained emergency solutions model to a real time input vector, according to embodiments of the present disclosure. In embodiments, the trained emergency solutions model 504 receives as input a real time input vector 505 comprising a plurality of records. In embodiments, the real time input vector can comprise one or more of an emergency notification data object (e.g., comprising an emergency notification identifier and possibly an emergency notification category and other pertinent information), one or more sensor data objects, a plurality of aircraft attributes, location coordinates, flight plan data (e.g., comprising coordinates associated with a take-off airport), weather data objects, terrain data objects, air traffic control (ATC) data objects, and/or FIXM/WXXM/AIXM data objects.

In embodiments, the trained emergency solutions model 504 is configured to generate an emergency solution data structure 506 in near real-time (e.g., without undue delay, or seemingly real-time to the pilots in the cockpit) based on the real time input vector 505. In embodiments, the emergency solution data structure 506 comprises an emergency solution instruction (e.g., one of jettison, burn, or jettison and burn combination). The emergency solution data structure 506 may further comprise one or more of a list of potential fuel reduction site identifiers, a preferred fuel reduction site identifier, preferred fuel reduction site location coordinates, an estimated time to clearance (e.g., a predicted amount of time after which ATC may provide approval for navigating to one or more of the preferred fuel reduction site or the landing airport location), an excess fuel amount to jettison and/or burn, landing airport coordinates, checklist procedure items that must be performed prior to fuel reduction, and/or a fuel reduction duration (i.e., how long the aircraft should maintain position to jettison and/or burn the excess amount of fuel).

The capabilities of the present disclosure can be implemented in software, firmware, hardware or some combination thereof.

As one example, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or sold separately.

Additionally, at least one program storage device readable by a machine, tangibly embodying at least one program of instructions executable by the machine to perform the capabilities of the present disclosure can be provided.

The flow diagrams depicted herein are just examples. There may be many variations to these diagrams or the steps (or operations) described therein without departing from the spirit of the disclosure. For instance, the steps may be performed in a differing order, or steps may be added, deleted or modified. All of these variations are considered a part of the claimed disclosure.

While the preferred embodiment to the disclosure has been described, it will be understood that those skilled in the art, both now and in the future, may make various improvements and enhancements which fall within the scope of the claims which follow. These claims should be construed to maintain the proper protection for the disclosure first described.

What is claimed is:

1. An apparatus for generating aircraft emergency solution data structures, the apparatus comprising at least one processor and at least one memory storing instructions that, with the at least one processor, cause the apparatus to:
receive an in-flight emergency notification data structure associated with an aircraft identifier, the aircraft identifier associated with an aircraft;
generate an aircraft emergency solution data structure, the aircraft emergency solution data structure based at least in part on the in-flight emergency notification data structure, aircraft location coordinates, and an aircraft attribute data structure, wherein the aircraft emergency solution data structure comprises excess fuel solution location coordinates, one or more of a fuel burn instruction or a fuel jettison instruction, and an excess fuel amount;
navigate the aircraft to a first location associated with the excess fuel solution location coordinates;
upon detecting that current aircraft location coordinates match excess fuel solution location coordinates, maintain an aircraft position in the current aircraft location coordinates for an excess fuel solution amount of time comprising an amount of time sufficient for an amount of fuel to be burned equivalent to the excess fuel amount or an amount of fuel to be jettisoned equivalent to the excess fuel amount; and
navigate the aircraft to a second location associated with landing airport coordinates.

2. The apparatus of claim 1, wherein generating the aircraft emergency solution data structure comprises applying a trained emergency solutions model to a real time input vector associated with the flight emergency notification data structure.

3. The apparatus of claim 1, wherein the trained emergency solutions model comprises decision trees.

4. The apparatus of claim 1, wherein the aircraft emergency solution data structure comprises a fuel jettison instruction and landing airport location coordinates, and wherein the excess fuel solution location coordinates are associated with one or a preferred fuel jettison site identifier selected from a list of candidate fuel jettison site identifiers or a preferred fuel burn site identifier selected from a list of candidate fuel burn site identifiers.

5. The apparatus of claim 4, wherein the at least one memory stores instructions that, with the at least one processor, further cause the apparatus to:
transmit one of the preferred fuel jettison site identifier and the list of candidate fuel jettison site identifiers or the preferred fuel burn site identifier selected and the list of candidate fuel burn site identifiers to an air traffic control (ATC) device.

6. The apparatus of claim 4, wherein selection of the excess fuel solution location coordinates is based in part on metadata or retrieved data associated with one or more of each candidate fuel jettison site identifier in the list of candidate fuel jettison site identifiers or each candidate fuel burn site identifier in the list of candidate fuel burn site identifiers.

7. The apparatus of claim 6, wherein the metadata or retrieved data comprises one or more of populated area data, weather conditions and altitude sufficient to vaporize jettisoned fuel prior to reaching a location associated with each candidate fuel jettison site identifier, present fuel conditions of the aircraft, or ability to maintain minimum five nautical miles between the aircraft and other aircraft.

8. The apparatus of claim 1, wherein the excess fuel amount is determined based at least in part on a first amount of fuel used by the aircraft during a first flight distance from a take-off airport to a current position of the aircraft plus a second flight distance from the current position of the aircraft to the excess fuel solution location coordinates plus a third flight distance of the aircraft from the excess fuel solution coordinates to the landing airport location coordinates.

9. The apparatus of claim 8, wherein the excess fuel amount is further determined by subtracting from a maximum take-off weight of the aircraft, a maximum landing weight of the aircraft and the excess fuel amount.

10. The apparatus of claim 1, wherein the memory further comprises instructions that cause the apparatus to:
retrieve one or more of enhanced ground proximity warning system (EGPWS) terrain data, weather data, navigation data from a navigation database, crowd-sourced sensor data, air traffic data, flight information exchange model (FIXM) data, weather information exchange model (WXXM) data, or aeronautical information exchange model (AIXM) data.

11. The apparatus of claim 1, wherein the memory further comprises instructions that cause the apparatus to:
render for display an interface comprising a graphical highway-on-the-sky map representative of a path to the excess fuel solution location coordinates.

12. The apparatus of claim 1, wherein the memory further comprises instructions that cause the apparatus to:
validate that a checklist procedure has been completed prior to jettisoning or burning fuel from the aircraft.

13. A method for generating aircraft emergency solution data structures, method comprising:
receiving an in-flight emergency notification data structure associated with an aircraft identifier, the aircraft identifier associated with an aircraft;
generating an aircraft emergency solution data structure, the aircraft emergency solution data structure based at least in part on the in-flight emergency notification data structure, aircraft location coordinates, and an aircraft attribute data structure, wherein the aircraft emergency solution data structure comprises excess fuel solution location coordinates, one or more of a fuel burn instruction or a fuel jettison instruction, and an excess fuel amount;
navigating the aircraft to a location associated with the excess fuel solution location coordinates; and
upon detecting that current aircraft location coordinates match excess fuel solution location coordinates, maintaining an aircraft position in the current aircraft location coordinates until one or more of an amount of fuel is burned equivalent to the excess fuel amount or an amount of fuel is jettisoned equivalent to the excess fuel amount.

14. The method of claim 13, wherein the aircraft emergency solution data object comprises a fuel jettison instruction and landing airport location coordinates, and wherein the excess fuel solution location coordinates are associated with a preferred fuel jettison site identifier selected from a list of candidate fuel jettison site identifiers.

15. The method of claim 14, further comprising:
transmitting the preferred fuel jettison site identifier and the list of candidate fuel jettison site identifiers to an air traffic control (ATC) device;
providing to a navigation system, the excess fuel solution location coordinates, wherein the navigation system is configured to navigate the aircraft to the location associated with the excess fuel solution location coordinates;
upon detecting that current aircraft location coordinates match excess fuel solution location coordinates, jettisoning a fuel weight amount from the aircraft equivalent to the excess fuel amount; and
providing to the navigation system the landing airport location coordinates, wherein the navigation system is configured to navigate the aircraft to a location associated with the landing airport location coordinates.

16. The method of claim 13, wherein the aircraft emergency solution data structure comprises a fuel burn instruction, and wherein the excess fuel solution location coordinates are associated with a burn jettison site identifier.

17. The method of claim 14, wherein selection of the excess fuel solution location coordinates is based in part on metadata associated with one or more of each candidate fuel jettison site identifier or each candidate fuel burn site identifier in a list of candidate fuel jettison site identifiers and candidate fuel burn site identifiers.

18. The method of claim 17, wherein the metadata comprises one or more of populated area data, weather conditions and altitude sufficient to vaporize jettisoned fuel prior to reaching a location associated with each candidate fuel jettison site identifier, present fuel conditions of the aircraft, or ability to maintain minimum five nautical miles between the aircraft and other aircraft.

19. The method of claim 17, wherein the excess fuel amount is determined based at least in part on a first amount of fuel used by the aircraft during a first flight distance from a take-off airport to a current position of the aircraft plus a second flight distance from the current position of the aircraft to preferred fuel burn site location coordinates.

20. The method of claim 14, wherein the excess fuel amount is determined based at least in part on a first amount of fuel used by the aircraft during a first flight distance from a take-off airport location to a current position of the aircraft plus a second flight distance from the current position of the aircraft to preferred fuel jettison site coordinates plus a third flight distance of the aircraft from the preferred fuel jettison site coordinates to the landing airport location coordinates.

21. The method of claim 20, wherein the excess fuel amount is further determined by subtracting from a maximum take-off weight of the aircraft, a maximum landing weight of the aircraft and the excess fuel amount.

22. The method of claim 13, further comprising:
retrieving one or more of enhanced ground proximity warning system (EGPWS) terrain data, weather data, navigation data from a navigation database, crowd-sourced sensor data, air traffic data, flight information exchange model (FIXM) data, weather information exchange model (WXXM) data, or aeronautical information exchange model (AIXM) data.

23. The method of claim 13, further comprising:
rendering for display an interface comprising a graphical highway-on-the-sky map representative of a path to the excess fuel solution location coordinates.

24. The method of claim 13, further comprising:
validating that a checklist procedure has been completed prior to jettisoning fuel from the aircraft.

25. A computer program product for generating aircraft emergency solution data structures, the computer program product comprising at least one non-transitory computer readable storage medium storing computer code that, when executed by at least one apparatus, cause the apparatus to:
receive an in-flight emergency notification data structure associated with an aircraft identifier, the aircraft identifier associated with an aircraft;
generate an aircraft emergency solution data structure, the aircraft emergency solution data structure based at least in part on the in-flight emergency notification data structure, aircraft location coordinates, and an aircraft attribute data structure, wherein the aircraft emergency solution data structure comprises excess fuel solution location coordinates, one or more of a fuel burn instruction or a fuel jettison instruction, and an excess fuel amount;
navigate the aircraft to a location associated with the excess fuel solution location coordinates; and
upon detecting that current aircraft location coordinates match excess fuel solution location coordinates, maintain an aircraft position in the current aircraft location coordinates until one or more of an amount of fuel is burned equivalent to the excess fuel amount or an amount of fuel is jettisoned equivalent to the excess fuel amount.
